(19) United States
(12) Patent Application Publication
(10) Pub. No.: US 2026/0204784 A1
(43) Pub. Date: Jul. 16, 2026

(54) DUAL FEED ANTENNA SYSTEM

(71) Applicant: ASUSTeK COMPUTER INC., Taipei (TW)

(72) Inventors: Yu-Ching Wu, Taipei (TW); Yu-Lin Hsieh, Taipei (TW); Yu-Yu Chen, Taipei (TW); Chun-Chieh Su, Taipei (TW)

(21) Appl. No.: 19/438,845

(22) Filed: Jan. 2, 2026

(30) Foreign Application Priority Data
Jan. 13, 2025 (TW) 114101377

(51) Int. Cl. H01Q 5/30; H01Q 1/22

(52) U.S. Cl. CPC H01Q 5/30; H01Q 1/22

(57) ABSTRACT

The disclosure provides a dual feed antenna system, which includes a metal radiating portion, a coupling metal portion, a first signal feed module and a second signal feed module. In the dual feed antenna system, the metal radiating portion is disposed on a frame of an electronic device, and there is a coupling distance between the coupling metal portion and the metal radiating portion. The first signal feeding module is electrically connected to the metal radiating portion to transmit and receive a first frequency band radio frequency signal through the metal radiating portion. The second signal feed module is electrically connected to the coupling metal portion to transmit and receive a second frequency band radio frequency signal through the coupling feed of the metal radiating portion and the coupling metal portion. Therefore, a shared metal radiating portion is used to achieve dual feed broadband operation.

### CROSS-REFERENCE TO RELATED APPLICATION

This application claims the priority benefit of Taiwan application serial No. 114101377, filed on Jan. 13, 2025. The entirety of the above-mentioned patent application is hereby incorporated by reference herein and made a part of specification.

### BACKGROUND OF THE INVENTION

### Field of the Invention

The invention relates to a dual feed antenna system that achieves multi-frequency operation via a single radiating portion.

### Description of the Related Art

With the great development of technology, electronic products are gradually popular, and functions become more powerful. Antennas are required for electronic products to transmit and receive radio frequency signals. However, with a high development of communication technology, electronic products need to support more types of radio frequency signals, such as 4G, 5G, and WIFI radio frequency signals. Consequently, more antennas need to be installed inside electronic products, and thus more internal space of electronic products is occupied. As a result, internal space of a small-sized portable electronic product with various functions is usually not enough.

### BRIEF SUMMARY OF THE INVENTION

A dual feed antenna system is provided. A dual feed antenna system, comprises: a metal radiating portion, disposed at a frame of an electronic device; a coupling metal portion, wherein a coupling distance is formed between the coupling metal portion and the metal radiating portion; a first signal feed module, electrically connected to the metal radiating portion, the first signal feed module transmits and receives a first frequency band radio frequency signal via the metal radiating portion; and a second signal feed module, electrically connected to the coupling metal portion, the second signal feed module transmits and receives a second frequency band radio frequency signal via coupling feed between the metal radiating portion and the coupling metal portion.

In summary, radio-frequency signals are feed into a same metal radiating portion of a dual-feed antenna system effectively by utilizing a direct feed and a coupling feed. With a shared metal radiating portion, the dual-feed antenna system provides a multi-frequency operation and broadband via dual feeds. As a result, the same metal radiating portion provides different usages of the metal radiating portion according to the requirements of different frequency band. Antenna radiation characteristics are good in a range of supported frequency bands.

### BRIEF DESCRIPTION OF THE DRAWINGS

FIG. 1 is a schematic diagram of a dual feed antenna system according to an embodiment of the invention.

FIG. 2 is a three-dimensional structure schematic diagram of a dual feed antenna system disposed inside an electronic device according to an embodiment of the invention.

FIG. 3 is a schematic diagram of S-parameter simulation of a dual-feed antenna system in various operating states according to an embodiment of the invention.

### DETAILED DESCRIPTION OF THE EMBODIMENTS

Embodiments of the invention are illustrated accompanying diagrams. In addition, some components or structures are omitted in the diagrams to clearly show technical features of the invention. In the diagrams, same or similar numerals denote the same or similar components or circuits. Terms such as “first”, “second” are used to describe various components, parts, regions or functions to distinguish one component, part, region or function from another.

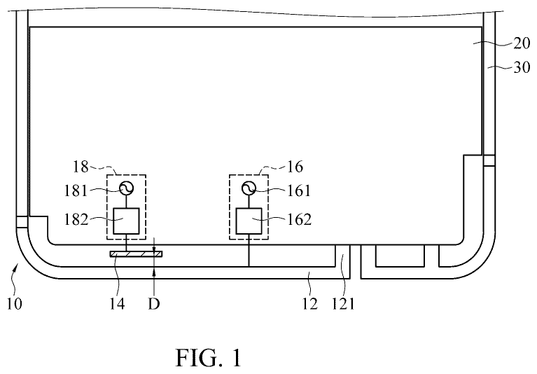

As shown in FIG. 1, a dual feed antenna system 10 is installed in an electronic device 30. The dual feed antenna system 10 includes a metal radiating portion 12, a coupling metal portion 14, a first signal feed module 16, and a second signal feed module 18. In the dual feed antenna system 10, the metal radiating portion 12 is formed at a frame of the electronic device 30. In an embodiment, the frame of the electronic device 30 is a metal frame. The metal frame is used as the metal radiating portion 12. In another embodiment, the electronic device 30 is a plastic frame, and the metal radiating portion 12 is formed at a metal portion or a metal strip at the frame, which is not limited herein. The metal radiation portion 12 is various according to applications of the dual-feed antenna system 10. The coupling metal portion 14 is disposed inside the metal radiating portion 12. A coupling distance D is formed between the coupling metal portion 14 and the metal radiating portion 12. The first signal feed module 16 is electrically connected to the metal radiating portion 12 to transmit and receive a first frequency band radio frequency signal via the metal radiating portion 12. The first frequency band radio frequency signal is a low frequency RF signal. The first signal feed module 16 includes a first signal source 161 and a first matching circuit 162. The first matching circuit 162 is electrically connected between the first signal source 161 and the metal radiating portion 12 to adjust and match signals. The second signal feed module 18 is electrically connected to the coupling metal portion 14 to transmit and receive a second frequency band radio frequency signal via coupling feed between the metal radiating portion 12 and the coupling metal portion 14. The second frequency band radio frequency signal is a medium to high range RF signal. The second signal feed module 18 includes a second signal source 181 and a second matching circuit 182. The second matching circuit 182 is electrically connected between the second signal source 181 and the coupling metal portion 14 to adjust and match signals. Consequently, the first signal source 161 cooperating with the first matching circuit 162 is used to directly feed into the metal radiating portion 12 to transmit and receive the first frequency band radio frequency signal. Furthermore, with the coupling effect of the coupling metal portion 14, the second signal source 181 cooperating with the second matching circuit 182 is used to feed into the same metal radiating portion 12 to transmit and receive the second frequency band radio frequency signal. As a result, the dual feed antenna system 10 has a dual feeding multi-frequency operation via a single metal radiating portion 12.

In an embodiment, as shown in FIG. 1, the dual feed antenna system 10 further includes a ground plane 20. The ground plane 20 is disposed in the electronic device 30. The metal radiating portion 12 includes a ground terminal 121 connected to the ground plane 20 to make the metal radiating portion 12 be electrically connected to the ground plane 20 via the ground terminal 121. Additionally, the coupling metal portion 14 is disposed between the metal radiating portion 12 and the ground plane 20.

In an embodiment, the electronic device 30 is a portable electronic device with mobile communication capabilities, such as a mobile phone, a personal digital assistant, a tablet computer, or a laptop, which is not limited herein. In the embodiment, the electronic device 30 is a portable electronic device. Components of the dual feed antenna system 10 are installed in the electronic device 30, and the ground plane 20 is a metal plane disposed at any appropriate position of the electronic device 30.

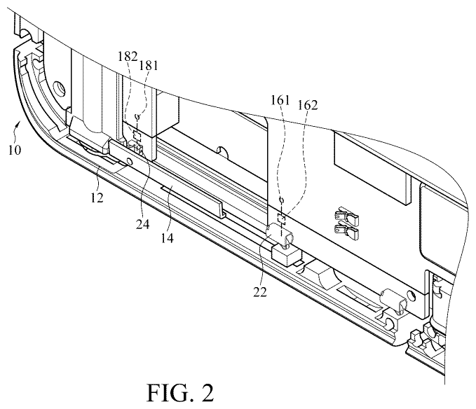

Please refer to FIG. 1 and FIG. 2, in an embodiment, the first matching circuit 162 is electrically connected to the metal radiating portion 12 via a first metal elastic sheet 22 to transmit signals effectively. The second matching circuit 182 is electrically connected to the coupling metal portion 14 via a second metal elastic sheet 24 to transmit signals effectively.

In an embodiment, the first matching circuit 162 and the second matching circuit 182 are various depending on an operating frequency of the antenna, characteristics of the antenna, and impedance requirements. They usually include integrated components such as capacitors, inductors, variable capacitors, and variable inductors according to practical requirements to convert input impedance of the antenna into standard impedance for the system.

In an embodiment, the coupling metal portion 14 is printed at a plastic portion of a speaker of the electronic device 30. The equivalent capacitance of a coupling area is able to be adjusted by adjusting a structural length printed at the plastic portion of the speaker.

In an embodiment, please refer to FIG. 1 and FIG. 2, the metal radiating portion 12 is in a bending shape according to the bending of the frame of the electronic device 30, which is not limited herein. In an embodiment, the metal radiating portion 12 is straight. In an embodiment, the length of the metal radiating portion 12 is between 40 mm and 60 mm.

Please refer to FIG. 1 and FIG. 2. In the dual-feed antenna system 10, when the first signal source 161 is fed into the metal radiating portion 12 via the first matching circuit 162, the metal radiating portion 12 excites a low-frequency operating mode. The resonance frequency is between 600 MHz and 960 MHz. The frequency and impedance matching of the low-frequency operating mode are adjusted by adjusting a length and a width of the metal radiating portion 12. The second signal source 181 is fed into the coupling metal portion 14 via the second matching circuit 182. The coupling metal portion 14 and the metal radiating portion 12 excites a medium-high-frequency operating mode. The resonance frequency is between 1710 MHz and 2690 MHz. The frequency and impedance matching of the medium-high-frequency operating mode can be adjusted by changing the length of the coupling metal portion 14 and the coupling distance D. Therefore, with the low-frequency operating mode and medium-high-frequency operating mode, without increasing an antenna size, the dual-feed antenna system 10 provides a range of low, medium, and high frequency bands for mobile communication.

Furthermore, with the coupling feed of the coupling metal portion 14, the equivalent capacitance generated via the coupling region of the coupling metal portion 14 is regarded as the capacitance of a high-pass filter. Therefore, without the need for additional components, the signal is blocked in the low-frequency band while the signal (the second frequency band radio frequency signal) in the medium-high-frequency band is able to pass through. Therefore, the dual-feed antenna system 10 has good isolation.

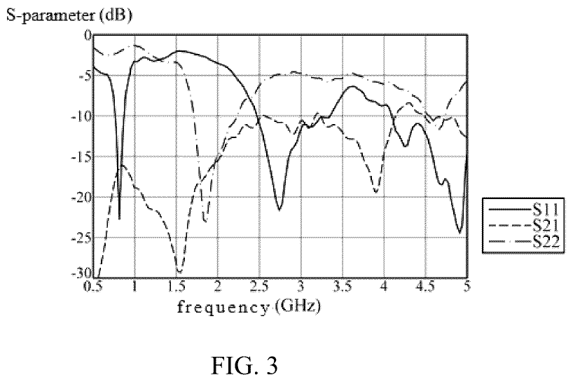

FIG. 3 is a schematic diagram of S-parameter simulation of a dual-feed antenna system in various operating states according to an embodiment of the invention. Please refer to FIG. 1 and FIG. 3. An S-parameter simulation analysis is carried out when the dual-feed antenna system 10 transmits radio-frequency signals to show that the dual-feed antenna system 10 has a good isolation effect. When the dual-feed antenna system 10 operates in the low-frequency operating band and the medium-high-frequency operating band respectively, S-parameter simulation results are shown in FIG. 3. As the curves shown in FIG. 3, both in the low-frequency operating band and the medium-high-frequency operating band, the return losses (S11, S22) are less than −10 dB (S11<−10 dB, S22<−10 dB). Reflection coefficients are good both in the low-frequency operating band and the medium-high-frequency operating band, and a broad operating frequency band is covered. The S-parameter at the isolation curve (S21) is less than −16 dB in the low-frequency operating band, and thus the good isolation in the low-frequency operating band greatly solves the problem of isolation between the two signal sources.

In summary, radio-frequency signals are feed into a same metal radiating portion of a dual-feed antenna system effectively by utilizing a direct feed and a coupling feed. With a shared metal radiating portion, the dual-feed antenna system provides a multi-frequency operation and broadband via dual feeds. As a result, the same metal radiating portion provides different usages of the metal radiating portion according to the requirements of different frequency band. Antenna radiation characteristics are good in a full range of supported frequency bands. Therefore, the dual-feed antenna system provides operating bandwidths of low-frequency band (600-960 MHz), medium-frequency band (1710 MHz-2170 MHz), and high-frequency band (2300-2690 MHz) for a mobile communication. A small-sized electronic device has broadband operation.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A dual feed antenna system, comprising:
a metal radiating portion, disposed at a frame of an electronic device;
a coupling metal portion, wherein a coupling distance is formed between the coupling metal portion and the metal radiating portion;
a first signal feed module, electrically connected to the metal radiating portion, the first signal feed module transmits and receives a first frequency band radio frequency signal via the metal radiating portion; and
a second signal feed module, electrically connected to the coupling metal portion, the second signal feed module transmits and receives a second frequency band radio frequency signal via coupling feed between the metal radiating portion and the coupling metal portion.

2. The dual feed antenna system according to claim 1, wherein the first signal feed module further includes:
a first signal source; and
a first matching circuit electrically connected between the first signal source and the metal radiating portion.

3. The dual feed antenna system according to claim 2, wherein the first matching circuit is electrically connected to the metal radiating portion via a first metal elastic sheet.

4. The dual feed antenna system according to claim 1, wherein the second signal feed module further includes:
a second signal source; and
a second matching circuit electrically connected between the second signal source and the coupling metal portion.

5. The dual feed antenna system according to claim 4, wherein the second matching circuit is electrically connected to the coupling metal portion via a second metal elastic sheet.

6. The dual feed antenna system according to claim 1, wherein the first frequency band radio frequency signal is a low frequency RF signal, and the second frequency band radio frequency signal is a medium to high range RF signal.

7. The dual feed antenna system according to claim 1, wherein the metal radiating portion further includes a ground terminal.

8. The dual feed antenna system according to claim 7, further comprising a ground plane in the electronic device, wherein the metal radiating portion is electrically connected to the ground plane via the ground terminal.

9. The dual feed antenna system according to claim 1, wherein the frame of the electronic device is a metal frame, and the metal frame is used as the metal radiating portion.

10. The dual feed antenna system according to claim 1, wherein the metal radiating portion is a metal portion or a metal strip at the frame of the electronic device.

11. The dual feed antenna system according to claim 1, wherein the coupling metal portion is printed at a plastic portion of a speaker of the electronic device.

12. The dual feed antenna system according to claim 1, wherein the electronic device is a mobile phone, a personal digital assistant, a tablet computer, or a laptop.
